(19) United States
(12) Patent Application Publication
(10) Pub. No.: US 2018/0008043 A1
(43) Pub. Date: Jan. 11, 2018

(54) CABINET INCLUDING AUXILIARY CABINET FACE FRAME

(71) Applicant: HOLM MILLWORKS AND MANUFACTURING, LLC, Knoxville, TN (US)

(72) Inventor: Nathaniel Lawrence Holm, Knoxville, TN (US)

(73) Assignee: HOLM MILLWORKS AND MANUFACTURING, LLC, Knoxville, TN (US)

(21) Appl. No.: 15/289,304

(22) Filed: Oct. 10, 2016

Related U.S. Application Data
(60) Provisional application No. 62/359,768, filed on Jul. 8, 2016.

(51) Int. Cl. A47B 95/04; E06B 1/52; E06B 1/58; E06B 1/60

(52) U.S. Cl. CPC A47B 95/04; E06B 1/60; E06B 1/52; E06B 1/58

(57) ABSTRACT

A cabinet including an original face frame and an auxiliary face frame attached to the original face frame. A method of updating a cabinet including an original face frame with an auxiliary face frame attached to the original face frame.

### CROSS-REFERENCE(S) TO RELATED APPLICATION(S)

This application claims priority to provisional application Ser. No. 62/359,768 filed on Jul. 8, 2016 and entitled “Auxiliary Cabinet Face Frame,” the entirety of which is incorporated herein by reference.

### FIELD

This disclosure relates to the field of cabinet face frames. More particularly, this disclosure relates to a cabinet including an auxiliary cabinet face frame.

### BACKGROUND

When apartments or homes undergo renovations, it often becomes necessary to completely remove old cabinets such as kitchen cabinets and replace them with new cabinetry that fits the style of the new décor. Completely replacing cabinets can be expensive and typically requires complete demolition of the old cabinetry.

Another option to change the look of cabinetry during a renovation is to just replace the doors on the cabinet and repaint or refinish the cabinet. This option is less expensive but it often does not significantly change the look or style of the cabinetry. Therefore, simply replacing cabinet doors and repainting provides limited flexibility when attempting to completely change the look and feel of a kitchen or other space that includes cabinets. Additionally, the option of resurfacing a cabinet with veneer has similar limitations on the ability to completely change the look of a cabinet, and a new veneer provides no new structural strength to the overall cabinet because it is only a very thin layer of material.

What is needed, therefore, is an option that allows an owner to make significant design changes to a room with cabinets while not having to completely replace the old cabinets.

### SUMMARY

The above and other needs are met by a cabinet including an auxiliary face frame. The cabinet also includes a cabinet box and an original face frame attached to the cabinet box. The auxiliary face frame is attached adjacent to the original face frame, covering the original face frame and providing a new structural facade to the cabinet. Preferably, one or more doors are attached to the auxiliary face frame. In some embodiments, the one or more doors are attached to the auxiliary face frame before the auxiliary face frame is attached adjacent to the original face frame.

In one embodiment, a cabinet apparatus as disclosed herein includes a cabinet box including at least one opening along a first side of the cabinet box, an original face frame attached to the first side of the cabinet box, and an auxiliary face frame attached to the original face frame. The cabinet apparatus further includes at least one door attached to the auxiliary face frame. The thickness of the auxiliary face frame preferably ranges from about 7.5 mm to about 25 mm, more preferably from about 10 mm to about 20 mm, and most preferably from about 12.5 mm to about 17.5 mm.

In a different embodiment, a method of attaching an auxiliary face frame to a cabinet including at least one opening along a first side of the cabinet box and an original face frame attached to the first side of the cabinet box is disclosed. The method includes the steps of measuring the cabinet box frame; applying adhesive along at least a portion of an edge of the original face frame; and attaching an auxiliary cabinet face frame to the original face frame. In one particular embodiment, the attaching step further includes nailing the auxiliary face frame to the original face frame. The measuring step may further include determining the amount of fill to be trimmed from each end of the auxiliary face frame and then trimming the auxiliary face frame. The measuring step may further include drilling a plurality of holes into the auxiliary face frame and drilling a plurality of holes into the original face frame.

One important advantage of the apparatus and method described herein is that they eliminate the need to remove an old cabinet or old cabinet face frame when remodeling the look of a particular cabinet. Instead, a prefabricated auxiliary face frame can be attached to the original face frame, thereby preserving the old cabinet and old face frame. Therefore, there is no cost to purchase a new cabinet box and no labor costs to demolish the old cabinet.

Because of the thickness and materials used to make the auxiliary face frame, one or more doors may be attached to the auxiliary face frame in a pre-fabrication setting, offsite from where the cabinet will be remodeled. The auxiliary face frame and any associated doors may be painted or otherwise treated at the pre-fabrication site so that there is relatively little work to do at the actual site where the cabinet is located.

The summary provided herein is intended to provide examples of particular disclosed embodiments and is not intended to cover all potential embodiments or combinations of embodiments. Therefore, this summary is not intended to limit the scope of the invention disclosure in any way, a function which is reserved for the appended claims.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a perspective view of a cabinet including an auxiliary face frame;

FIG. 2 shows a side view of the cabinet including the auxiliary face frame shown in FIG. 1;

FIG. 3 shows a perspective view of a cabinet including an original face frame and an auxiliary face frame including doors wherein the auxiliary face frame has not yet been attached to the original face frame;

FIG. 4 shows a side view of the cabinet, original face frame and auxiliary face frame shown in FIG. 3.

The figures are provided to illustrate concepts of the invention disclosure and are not intended to embody all potential embodiments of the invention. Therefore, the figures are not intended to limit the scope of the invention disclosure in any way, a function which is reserved for the appended claims.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

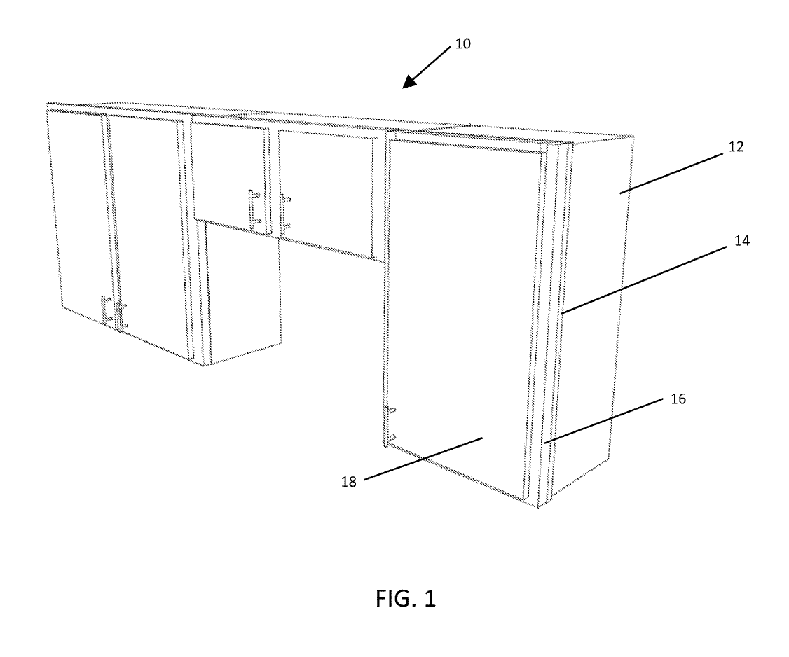

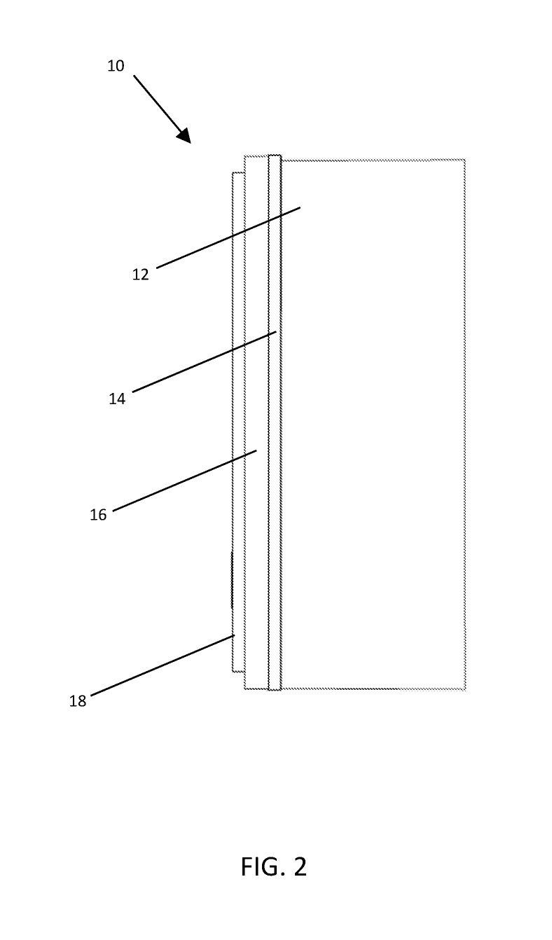

FIG. 1 and FIG. 2 show an embodiment of a cabinet 10 including a cabinet box 12 and an original face frame 14 attached thereto. An auxiliary face frame 16 is attached to the original face frame 14. Doors 18 are attached to the auxiliary face frame 16. Embodiments of auxiliary face frames described herein can be modular, covering a single cabinet box, or they can span multiple cabinet boxes. Cabinet doors can optionally be pre-hung on an auxiliary face frame or installed following the installation of the auxiliary face frame onto an original face frame.

Auxiliary cabinet face frames as described herein are preferably constructed of medium density fiberboard (MDS), particle board, plywood, and hard or soft woods. Auxiliary cabinet face frames can also be constructed of polycarbonates or other plastics or polymers as required by the particular application. The thickness of the material used for the auxiliary face frame preferably ranges from about 7.5 millimeters (mm) to about 25 mm, more preferably from about 10 mm to about 20 mm, and most preferably from about 12.5 mm to about 17.5 mm. Auxiliary cabinet face frames can be uncoated, painted, or have a plastic or polymeric covering layer or layers. The auxiliary face frames described herein are not veneers. Veneers are limited to the structure of the original face frame and veneers do not offer the structural support necessary for attaching cabinet doors thereto.

A method of installing an auxiliary cabinet face frame is also disclosed which includes a number of steps. An objective of the installation is to ensure adhesion of the pre-fabricated auxiliary face frame to the existing original face frame. Equipment needed preferably includes the following: a drill, preferably an electric drill; a drill bit, preferably 9.5 mm (⅜ inch); a nail gun, preferably an 18 gauge air-driven nail gun; and a caulk gun. Materials needed preferably include the following: nails, preferably 18 gauge nails from about 3.2 centimeters (cm) to about 3.4 cm (about 1.25 inches to about 1.34 inches) in length; and construction adhesive that preferably meets or exceeds ASTM C557 or ASTM D3948 standards. In a preferred embodiment, screws are included to attach the auxiliary face frame 16 to the original face frame 14. Although specific examples of tools and materials are provided herein, other embodiments of this method using other tools and other materials are contemplated as part of this disclosure.

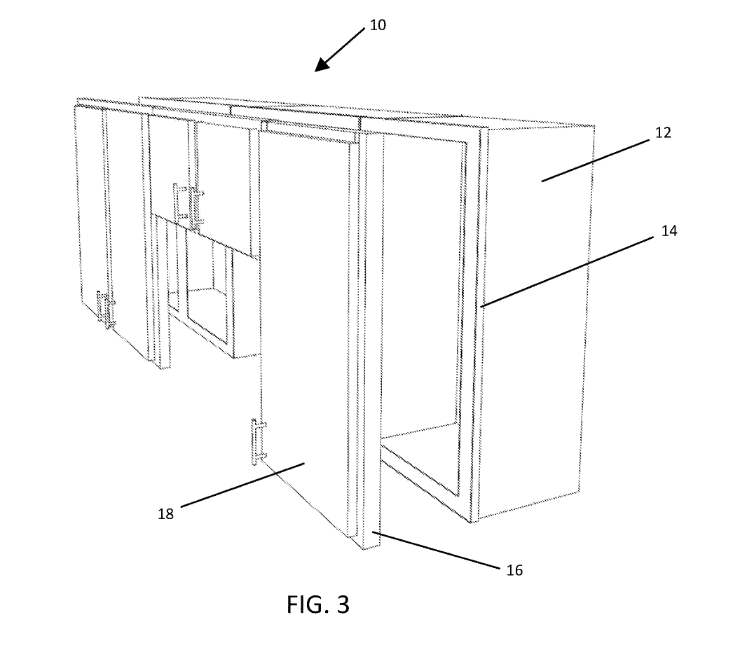

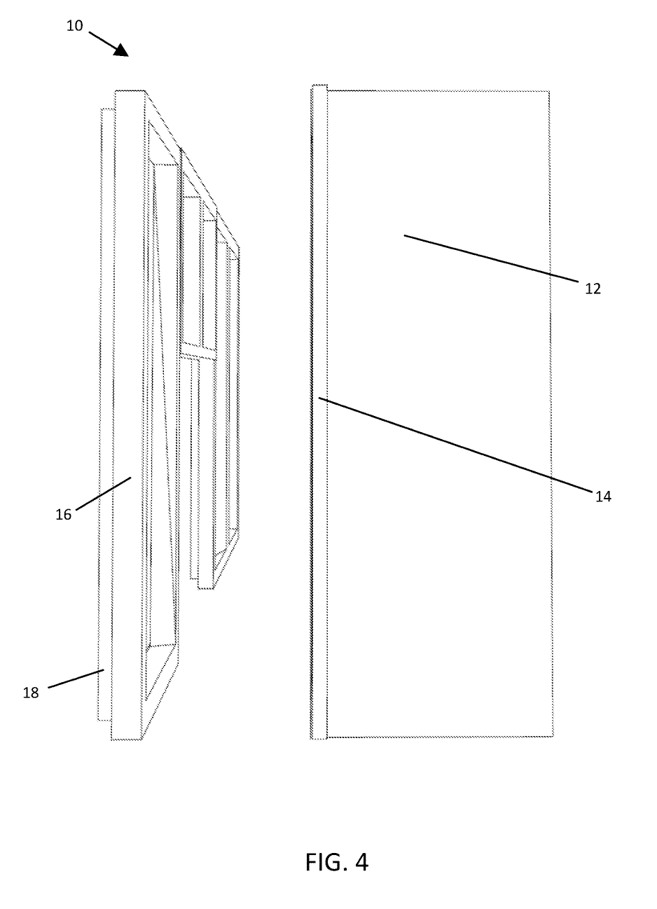

The following steps are provided as a preferred embodiment for attaching an auxiliary face frame to an original face frame, but other steps may be employed to form a cabinet including an auxiliary face frame. In this preferred embodiment, a first step for installing an auxiliary cabinet face frame includes measuring the cabinet boxes where the auxiliary face frame is to be installed. This step often includes determining the amount of fill to be trimmed from each end of the auxiliary face frame. As a second step, the auxiliary face frame is then trimmed as needed. A third step includes ensuring that existing center stiles align with the auxiliary face frame and adjust as needed. A fourth step includes drilling a plurality of holes into the auxiliary face frame wherein each hole is preferably from about 8 mm to about 11 mm in diameter and from about 5.5 mm to about 7 mm in depth and wherein the holes are spaced apart by at least about 20 cm (8 inches). A fifth step includes drilling a plurality of holes into the original face frame(s) wherein each hole is preferably from about 8 mm to about 11 mm in diameter and from about 8 mm to about 11 mm in depth and wherein the holes are spaced apart by at least about 20 cm (8 inches). A sixth step includes applying a bead of construction adhesive to at least a portion of an edge of the original face frame, and more preferably, to apply such adhesive to the entire edge of the original face frame. FIG. 3 and FIG. 4 show the cabinet from FIG. 1 and FIG. 2 prior to when the auxiliary face frame 16 is physically attached to the original face frame 14. A seventh step includes placing the auxiliary face frame in place against the original face frame. An eighth step includes nailing the auxiliary face frame to the original face frame, preferably with a minimum of about 20 cm between nails. Alternatively, screws may be used or other similar attachment materials known to a person having ordinary skill in the art. In one preferred embodiment, at least some screws are used and are inserted through the original face frame edges from inside the cabinet box 12. The screws penetrate through the original face frame 14 and go into the auxiliary face frame 16.

Another important aspect of the disclosure is a method for attaching cabinet doors to the auxiliary face frame without splitting the auxiliary face frame. The attaching step also must ensure that the attachment provides sufficient strength for the installed cabinet door hinges and doors. The equipment preferably used to accomplish this method include a drill, preferably an electric drill; a drill bit, preferably a 2.4 mm ( 3/32 inch) drill bit; and, optionally, an electric screw gun. Examples of materials needed include two 12.7 mm (0.5 inch) overlay hinges and two #6 3.2 cm (1.25 inch) coarse thread drywall screws. Although specific examples of tools and materials are provided herein, other embodiments of this method using other tools and other materials are contemplated as part of this disclosure.

The following steps are provided as a preferred embodiment but other steps may be employed. The first step of this preferred method includes attaching both hinges to a cabinet door using the provided screws. A second step includes aligning the door in the auxiliary face frame opening. A third step includes drilling a hole in the center of the auxiliary face frame using the provided drill bit and drilling to a depth of at least about 3 cm. A fourth step includes attaching the hinges to the auxiliary face frame using a single provided drywall screw per hinge.

The previously described embodiments of the present disclosure have many advantages, including reduced labor requirements for remodeling or rehabilitating a room (e.g., a kitchen). The reduced labor is a result of eliminating the need for demolition or resurfacing and/or painting of the original face frame. An auxiliary face frame can be prefabricated off site and brought to a work site ready to be attached directly to an original face frame. The prefabrication may include attaching doors to the auxiliary face frame and painting or otherwise treating the auxiliary face frame and doors. Because the auxiliary face frames are often prefabricated in this manner, significantly less time and effort is spent updating old cabinets with original face frames on the actual work site. Additionally, it becomes unnecessary to remove original face frames or old cabinets for remodeling projects.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A cabinet apparatus comprising a cabinet box including at least one opening along a first side of the cabinet box, a separate original face frame attached to the first side of the cabinet box, and a separate auxiliary face frame attached to the original face frame.

2. The cabinet apparatus of claim 1 further comprising at least one door attached to the auxiliary face frame.

3. The cabinet apparatus of claim 1 wherein the thickness of the auxiliary face frame ranges from about 7.5 mm to about 25 mm.

4. The cabinet apparatus of claim 1 wherein the thickness of the auxiliary face frame ranges from about 10 mm to about 20 mm.

5. The cabinet apparatus of claim 1 wherein the thickness of the auxiliary face frame ranges from about 12.5 mm to about 17.5 mm.

6. A method of attaching an auxiliary face frame to a cabinet including at least one opening along a first side of the cabinet box and an original face frame attached to the first side of the cabinet box, the method comprising the steps of:
a. measuring the cabinet box frame;
b. applying adhesive along at least a portion of an edge of the original face frame; and
c. attaching an auxiliary cabinet face frame to the original face frame.

7. The method of claim 6 wherein the attaching step of claim 6 further comprises nailing the auxiliary face frame to the original face frame.

8. The method of claim 6 wherein the measuring step further comprises determining the amount of fill to be trimmed from each end of the auxiliary face frame and then trimming the auxiliary face frame.

9. The method of claim 6 wherein the measuring step further comprises drilling a plurality of holes into the auxiliary face frame and drilling a plurality of holes into the original face frame.

10. The method of claim 6 wherein the attaching step further comprises inserting a plurality of screws through the back edges of the original face frame from inside the cabinet box and inserting the plurality of screws completely through the original face frame and into the auxiliary face frame.
